(19) United States
(12) Patent Application Publication
(10) Pub. No.: US 2006/0284977 A1
(43) Pub. Date: Dec. 21, 2006

(54) System and method for secure digital video

(75) Inventor: Pamela Richardson, Grapevine, TX (US)

Correspondence Address: DOCKET CLERK, P.O. DRAWER 800889, DALLAS, TX, 75380, US

(73) Assignee: Nortel Networks Limited

(21) Appl. No.: 11/471,872

(22) Filed: Jun. 21, 2006

Related U.S. Application Data
(60) Provisional application No. 60/692,680, filed on Jun. 21, 2005.

(51) Int. Cl. H04N 7/18

(52) U.S. Cl. 348/142

(57) ABSTRACT

A secure digital video system having a case made from hardened secure material, a router within the hardened case, the router capable of formatting secure data packets for transmitting video images across a secure network, and a camera securely connected to the router, wherein the camera is either built into the hardened case, attached to the hardened case such that no wires are exposed, or provides a secure path for communication lines connecting the video surveillance camera to the router. Also disclosed is a method for remote video monitoring. Image data can be marked with the time, date, and location at which the image was captured.

### CROSS-REFERENCE TO RELATED APPLICATION

This application claims the benefit of U.S. Provisional Patent Application 60/692,680, filed Jun. 21, 2005, which is hereby incorporated by reference.

### TECHNICAL FIELD OF THE INVENTION

The present disclosure is directed, in general, to digital video systems.

### BACKGROUND OF THE INVENTION

Digital camera systems are well known, including digital video cameras that can communicate using either a serial protocol or an internet protocol (IP protocol). These cameras are used for a wide variety of purposes, including for video communications when attached to a data processing system, or for remote monitoring of other locations when accessible over a network such as the Internet.

Some digital video camera systems are being used for security and monitoring purposes, such as for monitoring traffic conditions or office premises. While IP-based digital video cameras are particularly convenient for remote access, present cameras and their associated data feeds are not secure, and can be intercepted or “spoofed”.

There is, therefore, a need in the art for a system and method for secure digital video communication.

### SUMMARY OF THE INVENTION

To address the above-discussed deficiencies of the prior art, the disclosed embodiments provide for secure digital video using physical protection and encryption.

In accordance with one embodiment of the present invention, there is provided a secure digital video system, comprising a case made from hardened secure material; a router within the hardened case, the router capable of formatting secure data packets for transmitting video images across a secure network; and a camera securely connected to the router, wherein the camera is either built into the hardened case, attached to the hardened case such that no wires are exposed, or provides a secure path for communication lines connecting the video surveillance camera to the router.

In accordance with another embodiment of the present invention, there is provided a secure digital video system, comprising a case made from hardened secure material; a router within the hardened case, the router capable of formatting secure data packets for transmitting video images across a secure network; a camera securely connected to the router via a communication line that is secured against physical tampering, the communication line carrying encrypted data between the camera and the router; and at least one data processing system connected to communicate with the router across the secure network.

In accordance with another embodiment of the present invention, there is provided a method for remote video monitoring, comprising capturing image data using a digital camera, the digital camera secured against physical tampering; encrypting the image data; and transmitting the encrypted image data to a data processing system over a virtual private network.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a digital video system in accordance with a disclosed embodiment;

FIG. 2 depicts a block diagram of a network implementation including multiple digital video systems; and

FIG. 3 depicts a flowchart of a process in accordance with an embodiment of the present invention.

### DETAILED DESCRIPTION OF THE INVENTION

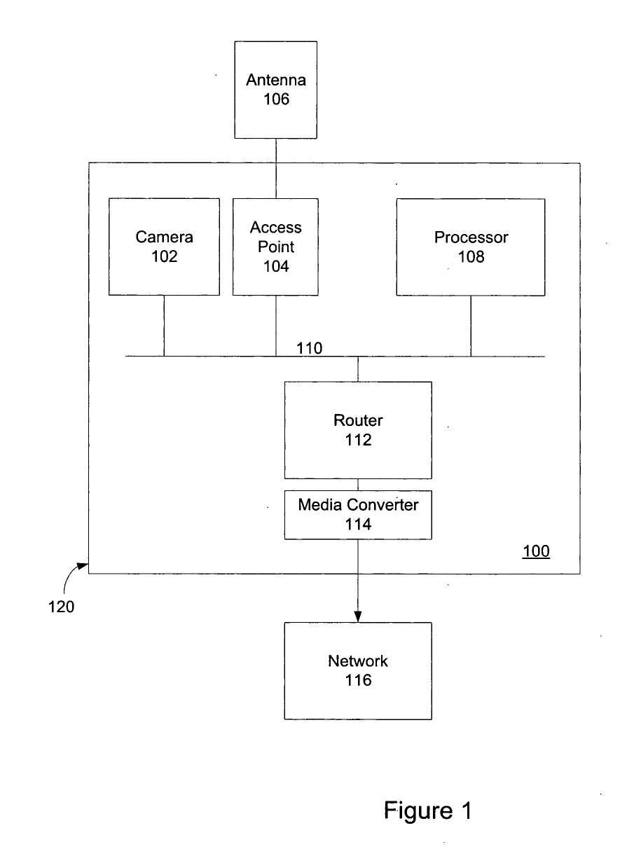

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

Various embodiments include a system and method for secure digital video. Most current systems transmit images across non-secure transport that is vulnerable to “hacking”. Various disclosed embodiments ensure that transmitted images are secure and encrypted from the digital video camera (or other image sensor) to the recipient data processing system. Some embodiments are particularly advantageous for use as part of a municipal security or surveillance infrastructure, where cameras can be mounted, for example, on street light poles and the image and control data can be transmitted over the city's digital infrastructure, typically a fiber-optic system. In these embodiments, the images going across the city fiber infrastructure is secured at the pole and encrypted appropriately prior to transmittal.

In various embodiments, a camera installation, such as at a light pole or building structure, includes the digital video camera itself, which may be a separate camera unit or appropriate imaging hardware and software integrated with other devices. Also included is a virtual private network (VPN) or similar router, allowing secure data communications to and from the camera. The router is capable of formatting secure data packets for transmitting video image data wirelessly or by way of physical connection (e.g., wired or optical) across a secure network. One router suitable for such an implementation is the NORTEL CONTIVITY, which provides 10/100 FX interfaces to extend IP-protocol communications to the camera for secure video surveillance technology.

FIG. 1 depicts a block diagram of a digital video system 100 in accordance with a disclosed embodiment. Digital video system 100 includes a camera 102, which can include any suitable imaging sensor (CCD, etc.) as known to those of skill in the art, and is typically a digital camera producing digital video data. For example, camera 102 can be a visible spectrum color or monochromatic camera, infrared or combination of the above. In some embodiments, camera 102 includes the capability for pan, tilt, and/or zoom functions, known to those of skill in the art, that can be remotely controlled. In some embodiments, the camera is capable of marking the digital video data with location, time, and date information. In this way, some or all digital video images can be automatically marked with the time, date, and place that the image was captured.

Digital video system 100 also includes, in some embodiments, a wireless access point 104 and one or more associated antenna 106. The wireless access point 104 can be implemented to communicate using any wireless protocol, and in some embodiments is compatible with IEEE 802.11 “WiFi” communications, IEEE 802.16 “WiMAX” communications, and/or IEEE 802.20 communications, as well as communications protocols promulgated by 3GPP and 3GPP2.

Digital video system 100 also includes a processor 108 capable of performing various processing tasks as described herein and those known to persons of skill in the art. Processor 108 can include appropriate processing circuitry encompassing one or more appropriate semiconductor devices such as ASICs, DSPs and the like. Processor 108, camera 102, and wireless access point 104 are all capable of communicating with a router 112 via communication lines 110, which can be comprised of one or more common communication buses or separate direct connections. In particular, processor 108 can perform video encoding processes from data received from camera 102, encryption processes, camera control processes, and communicate with remote data processing systems and servers. Processor 108, in some embodiments, can also manage communications and access of other devices with access point 104. In some embodiments, the processor 108 is capable of marking the digital video data with location, date, and time information. In this way, some or all digital video images can be automatically marked with the time, date, and place that the image was captured.

Router 112 can be implemented as a secure virtual private network (sVPN) router using encryption techniques known to those of skill in the art. In various embodiments, the router will use a strong encryption such as the Advances Encryption Standard (AES) defined in US FIPS PUB 197.

Digital video system 100 can also include a media converter 114 that is capable of converting between different digital media types, for example between standard copper wire-based Ethernet communications that can be used in digital video system 100 and a fiber-optic communication system such as 100FX, known to those of skill in the art. In some embodiments, the media converter 114 is connected to the router 112 to convert data signals to a protocol suitable for fiber-optic communications.

Digital video system 100 can be physically structured in various ways depending on implementation. In some implementations, camera 102, access point 104, processor 108, and router 112 are integrated as a single physical device, while in other implementations, the are implemented as separate devices. In particular, the camera 102 can be implemented as a separate device, mounted where an advantageous view is possible, as on a street light pole or side of a building, and connected to communicate with other elements via communication lines 110. Power (AC or DC) is supplied to the system 100 in a conventional manner and is converted by appropriate circuitry in a manner well known in the art.

Some embodiments include a case 120 made from hardened secure material around some or all elements of video system 100, to protect them from any tampering. For example, a hardened case can enclose camera 102, access point 104, processor 108, and router 112, and other elements, and any communication lines 110 can be similarly enclosed to prevent tampering. This is particularly advantageous where any interference or tampering with the video image data or other data must be prevented. In street light pole implementations, for example, the camera 102 and antenna 106 can be mounted high on the pole for best exposure, while other elements are located in a hardened enclosure or case in the pole base, and any communications lines between them are also enclosed. In some embodiments, camera 102 is either built into the hardened case, attached to the hardened case such that no wires are exposed, or provides a secure path for communication lines 110 connecting the video surveillance camera to the router 112. Also, in various embodiments, all data on communication lines 110 is also encrypted using known methods, and in these cases, camera 102, access point 104, processor 108, and router 112 can each perform any necessary encryption/decryption tasks.

The case 120 of hardened secure material can be any suitable material formed to house the video system 100 so that it is not easily accessible to an unauthorized user, but can be accessed by authorized users for maintenance or other purposes. Examples of a suitable case 120 include those formed from hardened steel or other metal and those formed from plastics such that they cannot be easily violated. In some embodiments, the case 120 is a locking enclosure securely attached to a light pole, building, or other fixture.

Various embodiments include an innovative design to harden ISO Layer 2/3 hardware providing access, security (via sVPN, for example), and wireless connectivity. It is an extensible and scalable solution that can be repeated as baseline architecture.

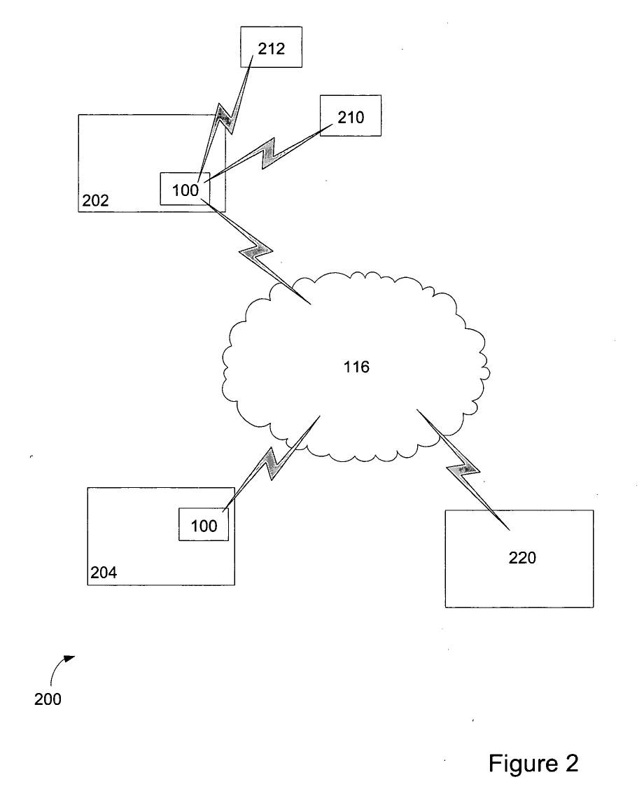

FIG. 2 depicts a block diagram of a network implementation including multiple digital video systems 100. Here, a video system 100 is depicted as mounted on (and in) a street light pole 202, and another video system 100 is depicted as mounted on a building 204. Each video system 100 communicates with network 116 as described above, using fiber optics, DSL, or other suitable data communications, and is preferably encrypted. Data processing system 220, which can be a server, a control system, or other data processing system, can communicate with and control digital video systems 100 via network 116, both sending camera control data to the camera and receiving digital video data from the camera.

In some embodiments, the access point 104 in video system 100 can communicate with additional wireless sensors or components 210 suitable for monitoring or surveilling an area in the case of a threat. These wireless components 210 can be mobile or can be moved to threat locations based on changing conditions.

In some embodiments, the access point 104 can provide mobile access from handheld or other computers 212, for street level access to sensor or surveillance components, including the camera 102, or as a gateway for further network access. In some embodiments, the surveillance components are treated as network appliances, known to those of skill in the art, and therefore fit into an easily understood architecture that does not rely on protocol conversion, adaptors, drivers, and does not suffer transport media-line loss often found in legacy systems. Moreover, the systems 100 can be arranged in a mesh or multi-hop network arrangement to provide for the conveyance of data to or from the systems.

As noted above, in some embodiments, pan-tilt-zoom (PTZ) control of camera 102 can be accessed by remote data processing systems or by a mobile asset to receive the digital video data and to control the camera using camera control data. In some embodiments, PTZ controls are handled in-band and do not require a serial communication implementation. In still other embodiments, the PTZ can be controlled in accordance with pre-programmed control stored in memory (not shown) and recallable upon receipt of input from a particular one or more sensors 210. For example, receipt of input from a specific sensor 210 could result in the PTZ directing the camera from its existing orientation to one capable of providing a view of the vicinity of that specific sensor's location.

In some multi-camera network implementations, the system uses multicasting (one-to-many) to reduce bandwidth requirements, using techniques known to those of skill in the art. In these cases, the system makes digital video data and other surveillance information available at any point in the network. Video is available on-demand by subscribing to a network stream. Subscription and unsubscribing from a network resource is managed by the network.

Network and surveillance system management can be handled by common and available tools using Simple Network Management Protocol (SNMP).

Advanced Quality of Service (QoS) rules and priorities can be applied to the network model to insure on-time delivery of video and surveillance information and to reduce network contention.

Various embodiments disclosed herein can be used to enable police, fire, SWAT, and Federal agencies the ability to respond to emergencies or threats at a street corner to control cameras and determine the best response to threats. This could include police placement, chemical sensors that were triggered, gun shot sensors and more. It brings many applications down to the mobile street for emergency responders.

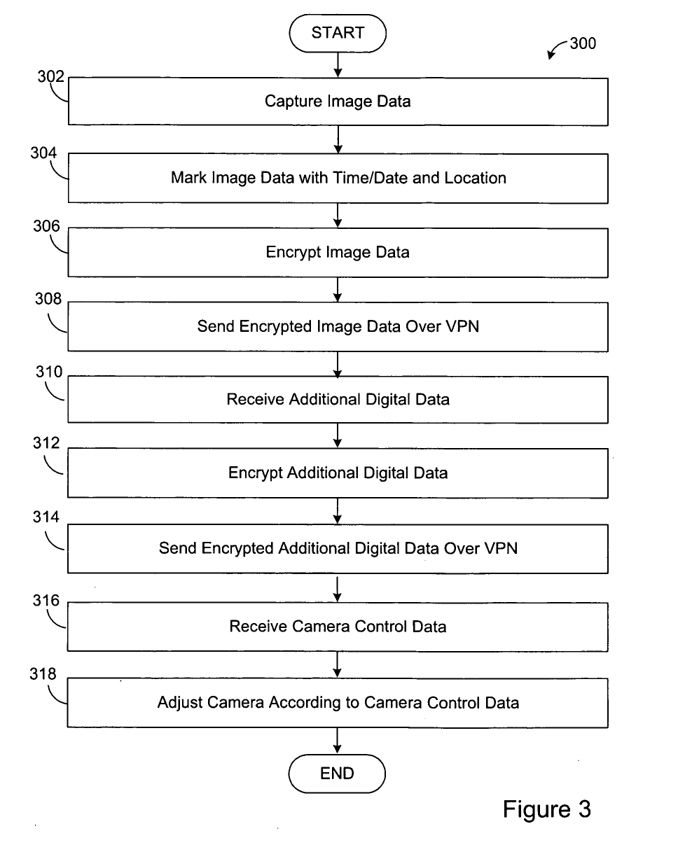

FIG. 3 depicts a flowchart of a process 300 in accordance with a disclosed embodiment. First, the camera captures image data (step 302), typically but not necessarily as a full-motion video stream or other digital video data as discussed above.

In some embodiments, the image data is be marked with information indicating the time, date, and location at which the image data was captured (step 304).

Next, the image data is encrypted by the camera (step 306). In some embodiments, the image data is encrypted using the advanced Encryption Standard (AES). In embodiments where the camera and router are integrated, the encryption can be performed by the router or processor.

Next, the encrypted image data is routed via a virtual private network to a data processing system (step 308). In some embodiments, this encrypted image data is transmitted using a one-to-many multicast.

Additional digital data, such as digital surveillance data, is received over a wireless access point (step 310), for example from surveillance components.

The additional digital data is encrypted by the wireless access point (step 312). In some embodiments, the image data is encrypted using the advanced encryption standard (AES). In embodiments where the wireless access point and router are integrated, the encryption can be performed by the router or processor.

Next, the encrypted additional digital data is routed via a virtual private network to a data processing system (step 314). In some embodiments, this encrypted additional digital data is transmitted using a one-to-many multicast.

Camera control data, including pan, tilt, or zoom commands, are received by the camera (step 316). The camera adjusts according to the camera control data (step 318).

Although FIG. 3 illustrates one example of a method 300 for digital image capture, various changes may be made to FIG. 3. For example, one, some, or all of the steps may occur as many times as needed. Also, while shown as a sequence of steps, various steps in FIG. 3 could occur in parallel or in a different order.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A secure digital video system, comprising:
a case made from hardened secure material;
a router within the hardened case, the router capable of formatting secure data packets for transmitting video images across a secure network; and
a camera securely connected to the router, wherein the camera is either built into the hardened case, attached to the hardened case such that no wires are exposed, or provides a secure path for communication lines connecting the video surveillance camera to the router.

2. The secure digital video system of claim 1, further comprising a wireless access point securely connected to communicate with the router.

3. The secure digital video system of claim 1, further comprising a processor connected to communicate with the router.

4. The secure digital video system of claim 1, further comprising a media converter connected to the router to convert data signals to a protocol suitable for fiber-optic communications.

5. The secure digital video system of claim 1, wherein the camera is responsive to visible or infrared light.

6. The secure digital video system of claim 1, wherein image data captured by the camera is marked with the time, data, and location at which the image data is captured.

7. The secure digital video system of claim 1, wherein the camera is capable of receiving and responding to camera control data.

8. The secure digital video system of claim 1, wherein the router supports the Advanced Encryption Standard.

9. The secure digital video system of claim 1, wherein the router provides a virtual private network connection to a data processing system network.

10. The secure digital video system of claim 2, wherein the access point is configured to communicate with wireless surveillance components.

11. The secure digital video system of claim 1, wherein data communications between the camera and the router are encrypted.

12. A secure digital video system, comprising:
a case made from hardened secure material;
a router within the hardened case, the router capable of formatting secure data packets for transmitting video images across a secure network;
a camera securely connected to the router via a communication line that is secured against physical tampering, the communication line carrying encrypted data between the camera and the router; and
at least one data processing system connected to communicate with the router across the secure network.

13. The secure digital video system of claim 12, wherein the data processing system is capable of sending camera control data to the camera.

14. The secure digital video system of claim 12, wherein the data processing system receives digital video data from the camera.

15. The secure digital video system of claim 12, further comprising a wireless access point securely connected to communicate with the router.

16. The secure digital video system of claim 15, wherein the access point is configured to receive surveillance data from wireless surveillance components.

17. The secure digital video system of claim 12, wherein image data captured by the camera is marked with the time, data, and location at which the image data is captured.

18. The secure digital video system of claim 12, wherein the router communicates using the Advanced Encryption Standard.

19. A method for remote video monitoring, comprising:
capturing image data using a digital camera, the digital camera secured against physical tampering;
encrypting the image data; and
transmitting the encrypted image data to a data processing system over a virtual private network.

20. The method of claim 19, further comprising
receiving digital surveillance data from at least one surveillance component;
encrypting the digital surveillance data; and
transmitting the encrypted digital surveillance data to the data processing system over the virtual private network.

21. The method of claim 19, further comprising marking the image data according to the time, date, and location at which the image data is captured.
